(19) United States
(12) Patent Application Publication
(10) Pub. No.: US 2015/0324560 A1
(43) Pub. Date: Nov. 12, 2015

(54) Abbreviated Authentication of an Electronic Device's User

(71) Applicant: Toshiba Global Commerce Solutions Holdings Corporation, Tokyo (JP)

(72) Inventors: Jeffrey Smith, Raleigh, NC (US); Brad M. Johnson, Raleigh, NC (US); Randall C. Humes, Raleigh, NC (US); Dean Frederick Herring, Youngsville, NC (US)

(73) Assignee: Toshiba Global Commerce Solutions Holdings Corporation, Tokyo (JP)

(21) Appl. No.: 14/274,283

(22) Filed: May 9, 2014

(51) Int. Cl. G06F 21/31; G06Q 20/20

(52) U.S. Cl. CPC G06F 21/31; G06Q 20/20

(57) ABSTRACT

A method authenticates a user of an electronic device located in and affiliated with a retail environment. The method includes prohibiting certain operations from being performed on the electronic device in a locked state. The method also includes, responsive to a user authenticating himself or herself through an authentication process, allowing those certain operations to be performed on the electronic device in an unlocked state. The method further entails configuring an extent to which the authentication process required for authentication at any given time is abbreviated. The method performs this configuring depending on whether operations performed on the electronic device at or within a defined interval before the given time are included in a defined list of operations. This defined list includes operations performed in the course of business associated with the retail environment.

### TECHNICAL FIELD

The present application generally relates to authenticating a user of an electronic device.

### BACKGROUND

Retail stores, shopping centers, and other retail environments increasingly use electronic devices for managing product inventory and for performing point-of-sale (POS) transactions. Especially as retail environments adopt mobile devices for such purposes, the devices tend to be more visible and physically accessible to retail customers. This of course remains particularly true for electronic devices that are intentionally made accessible to customers, including for instance self-serve kiosks and “in-store” product presentations. Electronic devices in this retail context are therefore quite susceptible to unauthorized use.

Numerous approaches exist for securing personal electronic devices outside of the retail context, including approaches that secure a personal device with a password. Various password-based approaches sometimes allow a user to enter only an abbreviated version of his or her password. None of these approaches however prove effective for use in a retail environment.

### SUMMARY

Teachings herein include methods and apparatus for authenticating a user of an electronic device. The teachings prove particularly advantageous for use in a retail environment.

More particularly, embodiments herein include a method for authenticating a user of an electronic device located in and affiliated with a retail environment. The method includes prohibiting certain operations from being performed on the electronic device in a locked state. The method further includes, responsive to a user authenticating himself or herself through an authentication process, allowing those certain operations to be performed on the electronic device in an unlocked state. The method further includes configuring an extent to which the authentication process required for authentication at any given time is abbreviated. The method configures the extent to which the authentication process at the given time is abbreviated depending on whether operations performed on the electronic device at or within a defined interval before the given time (i.e., “recently performed operations”) are included in a defined list of operations. In some embodiments, for example, the method configures the authentication process to be more abbreviated when the recently performed operations are included in the defined list and to be less abbreviated or not abbreviated at all when the recently performed operations are not included in the defined list. Regardless, the defined list of operations includes operations performed in the course of business associated with the retail environment with which the electronic device is affiliated and in which the electronic device is located.

In some embodiments, operations included in the list have been defined as operations for which the electronic device is intended. Alternatively or additionally, the defined list consists of operations associated with point of sale transactions in the retail environment.

In one or more embodiments, the method includes, responsive to determining that operations performed on the electronic device at or within the defined interval before the given time are not included in the defined list, generating an alert indicating such determination and outputting the alert.

Embodiments herein further include yet another method for authenticating a user of an electronic device. This method includes prohibiting certain operations from being performed on the electronic device in a locked state. The method also includes, responsive to a user authenticating himself or herself by inputting a defined subset of a password beginning from the start of the password, allowing those certain operations to be performed on the electronic device in an unlocked state. The method further includes determining the time taken by a user to input a particular portion of the password during an authentication attempt. The method does so by determining the time elapsed between when the user begins inputting that portion and when the user finishes inputting the portion. Finally, the method entails adjusting the length of the defined subset that the user must input for the authentication attempt, depending on the determined time.

In some embodiments, this adjusting involves at least one of decreasing the length of the defined subset if the determined time is less than a first threshold and increasing the length of the defined subset if the determined time is more than a second threshold. In this case, at least one of the first threshold and the second threshold may be set based on the time that an authenticated user has historically taken to input the portion.

Additionally or alternatively, the determining is performed as part of identifying a time-based signature with which the user inputs the defined subset. In this case, the signature is characterized by the time that the user takes to input different portions of the defined subset. The adjusting therefore comprises adjusting the length of the defined subset depending on the extent to which the signature matches a signature with which an authenticated user has historically input the defined subset.

Embodiments herein also include apparatus configured to perform or implement the above described methods. Embodiments further include corresponding computer programs and computer program products.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a retail store as one type of retail environment that includes an electronic device according to one or more embodiments.

FIGS. 2A-2B are block diagrams of an electronic device in a locked state and an unlocked state, respectively, according to one or more embodiments.

FIG. 3 is a logic flow diagram of a method for authenticating a user of an electronic device according to one or more embodiments.

FIGS. 4A-4B illustrate different lists of defined operations for configuring authentication process abbreviation according to alternative embodiments.

FIG. 5 is a logic flow diagram of a method for authenticating a user of an electronic device according to one or more other embodiments.

FIG. 6 illustrates an example of adjusting how much of a password a user must enter to be authenticated depending on how long the user takes to input particular portions of that password, according to one or more embodiments.

FIG. 7 is a graphic illustrating an example of how password length is adjusted depending on customer activity level according to one or more embodiments.

FIG. 8 is a block diagram of an apparatus configured to authenticate a user of an electronic device, according to one or more embodiments.

### DETAILED DESCRIPTION

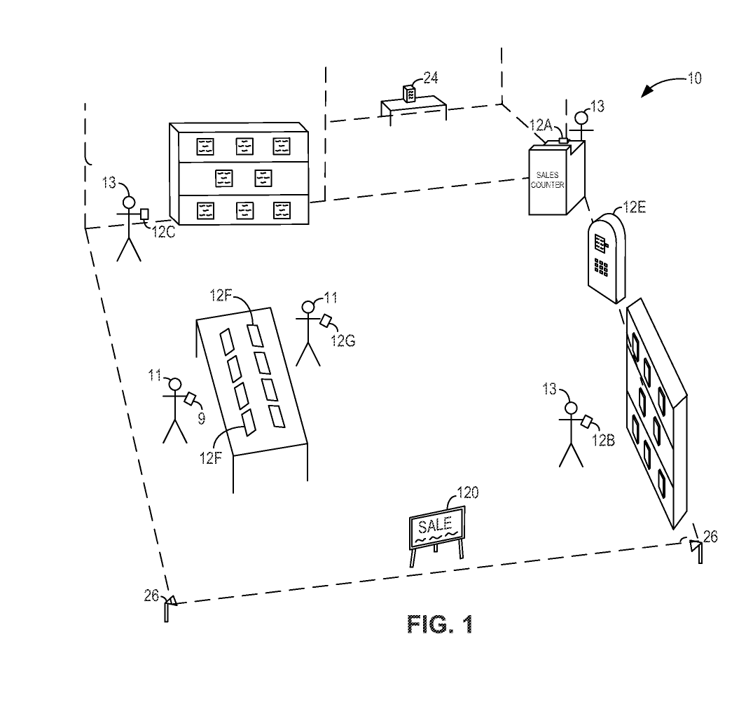

FIG. 1 shows a physical (i.e., “brick and mortar”) retail store 10 as one type of retail environment. One or more electronic devices 12 located in this retail environment are actually affiliated with the retail environment. As used herein, an electronic device 12 “affiliated with” a retail environment is owned, leased, or at least partly electronically controlled by the retail environment or by retail environment personnel to perform electronic operations in the course of the retail environment's business when the device 12 is located in the retail environment.

In some embodiments, a device 12 affiliated with the retail environment is owned or leased by the retail environment or by retail environment personnel. As shown in FIG. 1, for example, store personnel 13 use device 12A at a sales counter to perform point-of-sales (POS) transactions. In one such embodiment, device 12A is a “desktop” device or is otherwise dedicated for performing POS transactions locally at the sales counter. In other embodiments, device 12A is a “mobile” device or is otherwise configured to undock from the sales counter for performing transactions in a mobile fashion throughout the store 10. FIG. 1 shows device 12B as one such “mobile” device. Store personnel 13 also use device 12C as a “mobile” device for performing other retail-related tasks, such as performing inventory management. The store 10 also employs device 12D as a digital sign, such as to advertise sales or other retail information to customers. As another example of a store-affiliated device that is owned or leased by the store 10 or store personnel 13, the store 10 employs a kiosk 12E. This kiosk 12E is a stand-alone device that provides retail information and/or retail services (e.g., mobile checkout POS transactions) to customers through a user interface. As yet another example, the store 10 employs devices 12F as “in-store” product presentations. That is, devices 12F are working versions of products sold by the store 10, often with software loaded thereon that limits the operations customers may perform on the device. The store 10 makes the devices 12F available to be used by customers 11 so that customers 11 can test out the devices 12F before deciding to purchase the devices 12F.

In other embodiments, a device 12 affiliated with the retail environment is actually owned by a customer 11 but is configured to perform certain retail-related operations under the control of the retail environment when the device 12 is located in that retail environment (i.e., when the customer 11 brings his or her device 12 into the retail environment). As shown in FIG. 1, for example, customer-owned device 12G has installed thereon a software application that provides retail information and/or retail services to the customer 11. The software application may be configured to perform some operations, such as accessing store and product information, when the device 12 is not located in the retail environment (i.e., when the device 12 is not communicatively connected to the retail environment via a local connection). However, the software application is configured to perform other operations, such as scanning products to be purchased and performing mobile checkout POS transactions, only under the electronic control of the retail environment and thereby only when the device 12 is located in the retail environment. Such electronic control in some embodiments is performed by another apparatus 24 (e.g., a server) in or otherwise associated with the retail environment, such as by the apparatus 24 providing the software application with certain information (e.g., UPC codes and/or SKU numbers). Regardless, customer-owned device 12G as shown in FIG. 1 is contrasted with customer-owned device 9. Such device 9 is not configured to perform retail-related operations under the control of the retail environment when the device 9 is located in the environment (e.g., the device 9 does not have the above-described software application installed thereon).

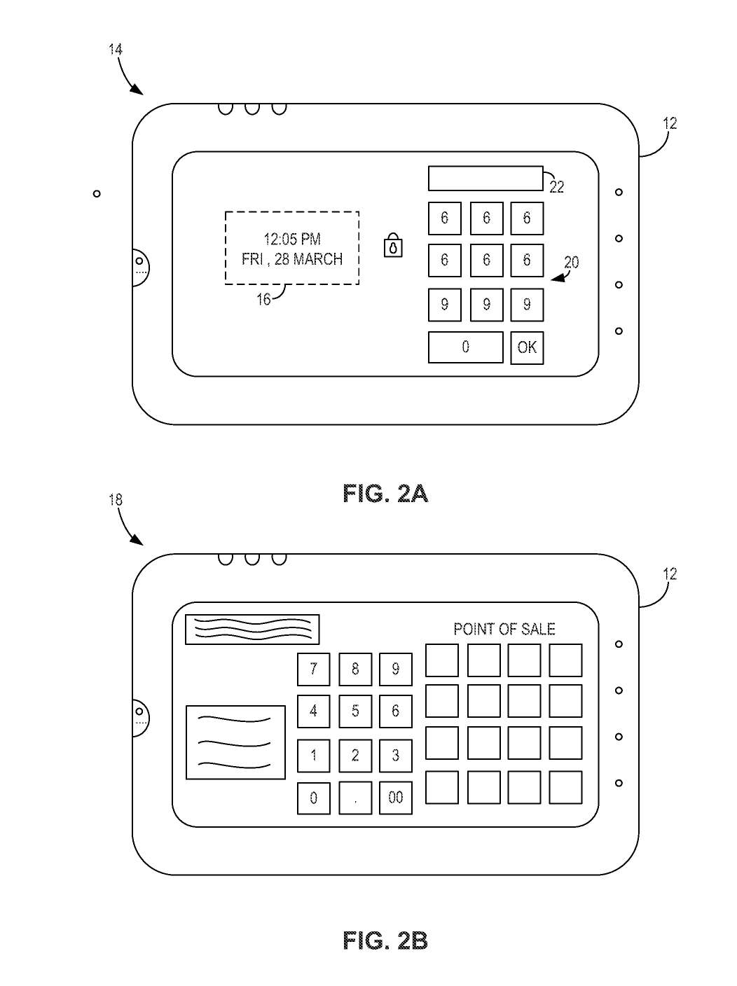

No matter the particular type of retail-affiliated device 12, the store 10 secures one or more of these affiliated devices 12 from unauthorized use. Such securing may be performed on the device-level, the application-level, the operation-level, or on any other level of granularity. In some embodiments, for instance, the store 10 secures devices 12A-12D on the device-level so as to prevent unauthorized users (e.g., customers 11) from performing any operations on the devices. By contrast, the store 10 may allow anyone (including customers 11) to perform certain limited operations on devices 12E-12F (e.g., for non-sensitive or demo purposes), but may secure devices 12E-12F on an application-level or operation-level to prevent unauthorized users from performing more sensitive operations. Limited operations that are allowed outright may include for instance accessing publicly available information or using benign applications (e.g., an internet browser), while sensitive operations that are secured may include accessing confidential (e.g., user-specific) information or using financial-related applications (e.g., applications for conducting POS transactions). With regard to customer-owned yet retail-affiliated device 12G, the store 10 may secure the device 12G in the sense that it secures the store's software application on the device 12G from unauthorized use. The store 10 in this regard may do so by securing the software application as a whole (i.e., on the application-level) or by securing particular operations that may be performed by or within the software application (i.e., on the operation-level). Regardless, the store 10 secures an affiliated device 12 by configuring the device 12 to operate in a locked state unless and until a user authenticates himself or herself, e.g., to the device 12 itself or to another apparatus 24 (e.g., a server) associated with the store 10. The device 12 or other apparatus 24 that authenticate a user thereby controls whether certain operations are allowed to be performed on the device 12 or whether those operations are prohibited from being performed on the device 12. FIGS. 2A-2B illustrate an example in this regard.

FIG. 2A shows a device 12 operating in a locked state 14. In the locked state 14, the device 12 or other apparatus 24 prohibits certain operations from being performed on the device 12. Which particular operations are prohibited depends on whether the device 12 is secured on a device-level, an application-level, or operation-level as described above, all of which to some extent prohibit certain operations from being performed. FIG. 2A shows a device 12 secured at the device-level. In the illustrated example, this means that the device 12 just displays limited information 16 (e.g., the date and time or other non-sensitive information), but prevents any applications or operations from being executed. In other embodiments, though, the locked state 14 allows very limited operations to be executed on the device 12, such as camera operations or other non-sensitive operations.

FIG. 2B shows the device 12 operating in an unlocked state 18. In the unlocked state 18, the operations that were prohibited in the locked state 14 are allowed to be performed. As shown in FIG. 2B, for example, applications used in the course of the store's business operations, such as those for performing POS transactions, are prohibited in the locked state 14 but allowed in the unlocked state 18.

The device 12 or other apparatus 24 allows transition from the locked state 14 to the unlocked state 18 responsive to a user authenticating himself or herself through an authentication process. As used herein, an authentication process is any process by which the electronic device 12 or other apparatus 24 validates with some degree of confidence the identity of the user attempting to transition the device 12 to the unlocked state. The electronic device 12 or other apparatus 24 does so based on something the user has (e.g., a security token), something the user knows (e.g., a password), and/or something the user is or does (e.g., a biometric identifier). The authentication process in some embodiments involves a single authentication method (e.g., involves the user either just entering a password or just providing a fingerprint). In other embodiments, the authentication process involves multiple authentication methods used in combination (e.g., involves the user both entering a password and providing a fingerprint). Note that a password as used herein includes a text password, a number password (also referred to as a PIN), a graphical password, a pattern password, or the like.

As a simple example, FIG. 2A shows an authentication process that involves just a single authentication method; namely, a method that only requires the user to enter a numeric password (also referred to as a PIN). The device 12 as shown presents on a touchscreen a numeric keypad 20 via which the user enters a numeric password into a password field 22.

Irrespective of the particular authentication process employed, one or more embodiments herein advantageously tailor that process for use in a retail environment. Specifically in this regard, the one or more embodiments recognize and address a unique balance that should be struck in a retail environment; namely, a balance between (1) raising barriers to deter operation of devices 12 that are especially sensitive due to their retail affiliation; and (2) lowering barriers to encourage quick operation of retail-affiliated devices 12 so as to realize prompt customer service.

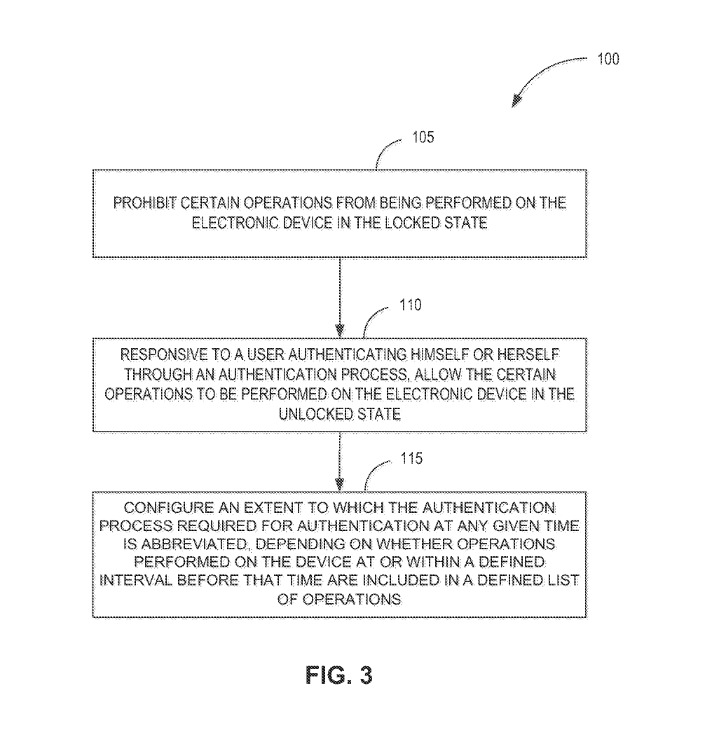

As one such embodiment, FIG. 3 illustrates a method 100 for authenticating a user of an electronic device 12 located in and affiliated with a retail environment (e.g., retail store 10). The method 100 is implemented by the device 12 itself in some embodiments, but in other embodiments is implemented by another apparatus 24 associated with the retail environment. The method 100 includes prohibiting certain operations from being performed on the electronic device 12 in a locked state (Block 105). The method 100 also includes, responsive to a user authenticating himself or herself (to the apparatus implementing the method 100) through an authentication process, allowing those certain operations to be performed on the electronic device 12 in an unlocked state (Block 110). Authentication in some embodiments may occur at either or both of the hardware level or the software level of the apparatus implementing the method 100.

In any event, the method 100 further includes configuring an extent to which the authentication process required for authentication at any given time is abbreviated (Block 115), e.g., as compared to the nominal authentication process. In embodiments where the authentication process involves the user entering a password, for example, the method 100 configures an extent to which the password required at the given time is abbreviated in length. For instance, rather than requiring the user to enter the nominal, full-length password “1234” that has been set up, the method 100 sometimes allows the user to just enter an abbreviated version of that password (e.g., “123”). No matter the particular authentication process, though, the extent to which the authentication process is abbreviated reflects the extent to which the authentication process requires less user input and/or requires less time than when that process is not abbreviated.

Regardless, the method 100 configures the extent to which the authentication process at the given time is abbreviated depending on whether operations performed on the device at or within a defined interval before the given time (i.e., “recently performed operations”) are included in a defined list of operations. In some embodiments, for example, the method 100 configures the authentication process to be more abbreviated when the recently performed operations are included in the defined list and to be less abbreviated or not abbreviated at all when the recently performed operations are not included in the defined list. Regardless, this defined list of operations is a list of operations that are performed in the course of the business associated with the retail environment; that is, the retail environment with which the device 12 is affiliated and in which the device 12 is located.

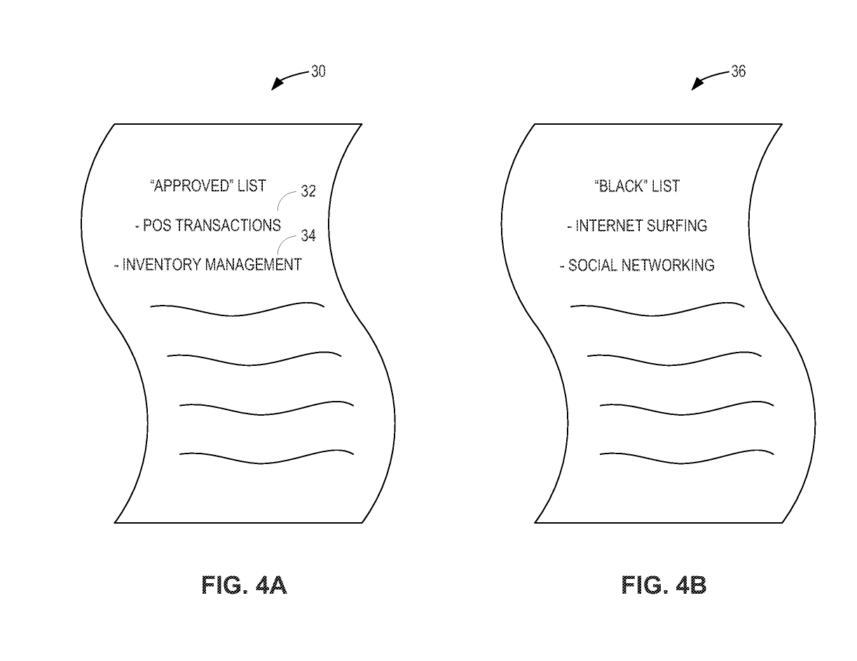

As shown in FIG. 4A, for instance, a defined list 30 of operations includes operations for inventory management 32, POS transactions 34, or any other operations that are approved (e.g., by retail management) as being regularly or occasionally needed to carry out the retail environment's business. The defined list 30 of operations as shown therefore excludes for instance internet surfing or social networking, at least to the extent that those are outside the scope or inconsistent with the retail environment's business operations.

In any event, if the recently performed operations are not within the defined list, the method 100 recognizes that the device 12 is likely not being operated by authorized retail personnel and therefore increases security by reducing the extent of abbreviated authentication. On the other hand, if the recently performed operations are within the defined list, the method 100 recognizes that the device 12 is likely being operated by authorized retail personnel and therefore decreases security by increasing the extent of abbreviated authentication.

In some embodiments, the method 100 further includes generating an alert indicating that the recently performed operations are not included in the defined list and then outputting that alert. In the retail context, for instance, the alert may be transmitted to retail management or security personnel in order to notify them that the device 12 is likely being used inappropriately (e.g., not within the scope of the retail environment's business operations). In at least one embodiment, the method 100 configures the authentication process to be unabbreviated until such a time as a remedy (to the device 12 or device user) has been put in place, e.g., to reset the device 12.

While described in some of the examples above as if the defined list of operations includes “approved” operations, in other embodiments the defined list may include “blacklisted” or “unapproved” operations. That is, rather than increasing security if recently performed operations are not included in a list of “approved” operations, the embodiments increase security if recently performed operations are included in a list of “blacklisted” operations. See, for instance, the “blacklist” 36 shown in FIG. 4B.

Although the embodiments of FIG. 3 were illustrated as particularly advantageous in the retail context, the embodiment prove effective in others contexts as well. Such other contexts include for instance educational environments or any other environment where a device is capable of performing numerous operations but is only intended for certain ones of those operations. In a broad sense, therefore, the defined list of operations in FIG. 3 may be a list of operations that have been defined as operations for which the device is intended.

Irrespective of the particular basis for configuring the extent of abbreviated authentication, the method 100 may configure that extent by selecting between different possible (i.e., candidate) configurations for the authentication process. In one embodiment, for example, the method 100 selects between alternative versions of a particular authentication method (e.g., a method that requires the user to enter a password). In this case, different versions each require a different amount of user input (e.g., a different password length, whereby one version requires a full password and another version requires a proper subset of that full password). Extended to authentication processes that combine multiple authentication methods, the method 100 in other embodiments selects between different sets of authentication methods that each comprise a different number of authentication methods used in combination (e.g., a first set that uses only a retina scan so as not to use any methods in combination, and a second set that uses a retina scan and a password in combination).

While some of the embodiments above were illustrated using the example of a retail store, embodiments herein apply generally to any retail environment. A retail environment as used herein is a physical environment (as opposed to an online or electronic environment) in which goods and/or services are sold to the public (i.e., end users or consumers) by retail. A retail environment includes not only a retail store, but also a collection of retail stores such as a shopping center or shopping mall as a whole.

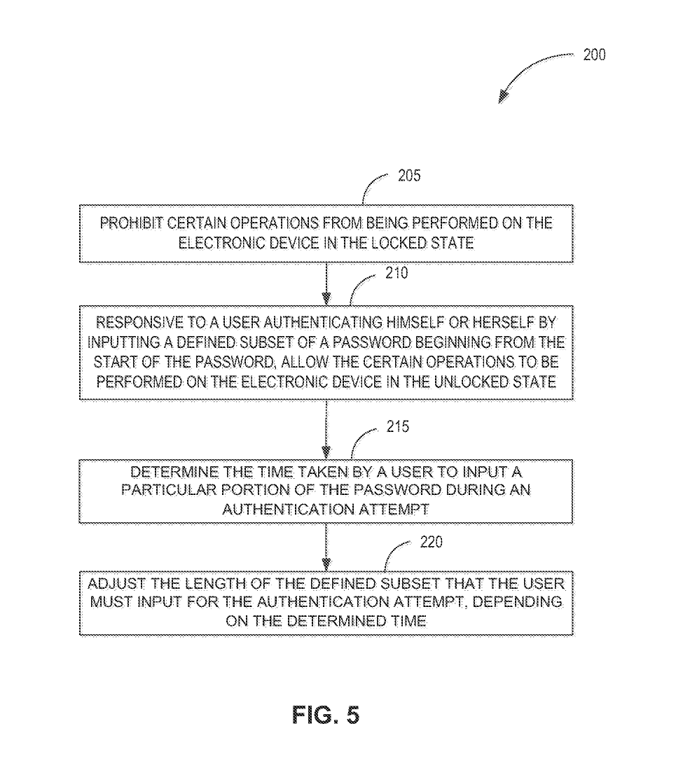

Additionally or alternatively to the embodiments above, FIG. 5 illustrates a method 200 for authenticating a user of an electronic device (e.g., affiliated device 12 or customer-owned device 9). The method 200 similarly includes prohibiting certain operations from being performed on the electronic device in a locked state (Block 205). The method 200 also includes, responsive to a user authenticating himself or herself by inputting a defined subset of a password beginning from the start of the password, allowing those certain operations to be performed on the electronic device 12 in an unlocked state (Block 210).

Note that “subset” here invokes the term's mathematical sense in that the subset may be either just a portion of the password or the full password. However, the subset as noted above must begin from the start of the password. For instance, if the password is “123456”, the subset may be “123” or “123456” but not “234”. Whether the subset is defined as “123” or “123456” at a given time depends on what the length of the subset is configured to be at that time (e.g., whether the subset's length at the time is configured to be 3 or 6), as described more fully below. Regardless of what the subset is defined to be at a particular time, the user authenticates himself or herself by inputting that subset. That is, if the subset is defined to be “123”, the user authenticates himself or herself by just inputting “123”; the user need not enter the full-length password of “123456” to be authenticated.

With this in mind, the method 200 further includes determining the time taken by a user to input a particular portion of the password during an authentication attempt (Block 215). This involves determining the time elapsed between when the user begins inputting that portion and when the user finishes inputting that portion. In some embodiments, such determination entails actually measuring the elapsed time, while in other embodiments the determination involves receiving a report from another node that performs such measurement. Regardless, unlike the “subset” discussed above, this portion need not begin from the start of the password. That is, the “portion” here may be “123” or “234” where the full-length password is “123456”, meaning that the method 200 would measure the time that it takes the user to enter “123” or “234” during an authentication attempt.

In any event, the method 200 finally entails adjusting the length of the defined subset that the user must input for the authentication attempt, depending on the determined time (Block 220). That is, how much of the password the user must enter during an authentication attempt (i.e., the length of the defined subset) depends on how long the user takes to enter a particular portion of the password. For example, how much of the full-length password “123456” the user must enter during an authentication attempt depends on how long the user takes to enter “123”.

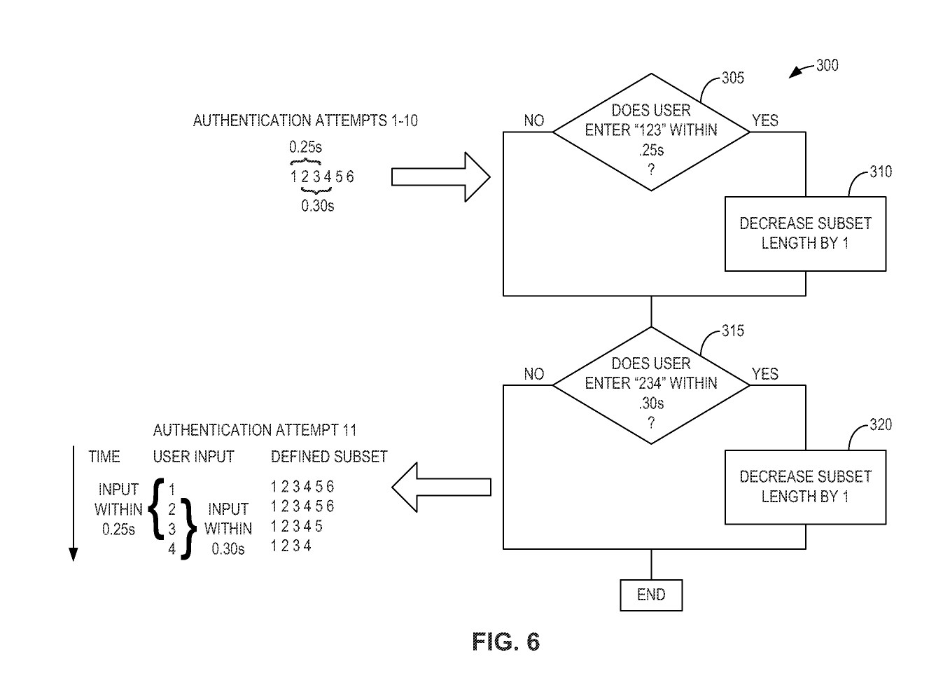

In some embodiments, the subset length adjustment decreases the length of the subset if the determined time is less than a first threshold. In one such embodiment, this first threshold is set based on the time that an authenticated user has historically taken to input the portion of the password being measured. FIG. 6 shows an example of this, in a context where the subset length adjustment depends on how long the user takes to enter multiple different portions of the password (meaning that there are multiple corresponding thresholds defined for those different portions).

As shown in FIG. 6, the method 200 initially collects historical information regarding how long the user typically takes to enter in different portions of the full-length password. For the first ten authentication attempts, the method 200 requires the user to enter in the full-length password “123456”. For each attempt, the method 200 determines the time taken by the user to input “123”. The method 200 also determines the time taken by the user to input “234”. Based on these measurements, the method 200 sets different thresholds corresponding to these different portions of the password. In some embodiments, the different thresholds are set as the average or maximum times that the user has historically taken to input the different portions of the password. Of course, any other statistic besides average or maximum time may be used, so long as the threshold represents some sort of realistic expectation on how long the user should take to enter a particular password portion in the future. As shown, the method 200 sets a threshold of 0.25 seconds for a user to enter “123” and a threshold of 0.30 seconds for a user to enter “234”, e.g., based on the user taking a maximum of 0.25 second and 0.30 seconds to respectively enter “123” and “234” over the course of the first ten authentication attempts. In at least some embodiments, the method 200 only considers successful authentication attempts in the calculation of such thresholds.

Having set these thresholds, method 300 is executed during subsequent authentication attempts in order to adjust the length of the defined subset that the user must input for those attempts. As shown, the method 300 includes determining whether the user inputs “123” within the 0.25 second threshold (Block 305). If so, the method 300 entails decreasing the length of the defined subset by 1 (Block 310). Otherwise, the method 300 may keep the length of the defined subset the same. The method 300 then includes determining whether the user inputs “234” within the 0.30 second threshold (Block 315). If so, the method 400 entails decreasing the length of the defined subset by 1 (Block 320). Again, otherwise, the method 400 may keep the length of the defined subset the same.

Illustrating the method 300 in the context of a subsequent authentication attempt (i.e., attempt number 11), FIG. 6 shows that the method sets the length of the defined subset to six by default; that is, the defined subset is initialized to the full-length password of “123456”. As the user is inputting the password during attempt 11, the method is determining the time taken by the user to do so. Specifically, when the user inputs “1”, the method in some embodiments starts a first timer. When the user inputs “2”, the method starts a second timer. At this point, the defined subset still has a length of six (i.e., is still “123456”). When the user inputs “3”, though, the method stops the first timer and determines whether the user input “123” within the 0.25 second threshold (Block 305). In this example, the user did input “123” within this threshold, so the method decreases the length of the defined subset by 1 (Block 310). That is, the defined subset is now “12345” rather than “123456”, meaning that the user need not enter the full-length password to be authenticated. When the user then inputs “4”, the method stops the second timer and determines whether the user input “234” within the 0.30 second threshold (Block 315). In this example, the user did input “234” within this threshold, so the method again decreases the length of the defined subset by 1 (Block 320). That is, the defined subset is now “1234” rather than “12345”, meaning that the user need not enter any more of the password to be authenticated.

Although in the example of FIG. 6 the length of the defined subset was set to the length of the full password by default, such need not be the case. In fact, the default subset length in alternatives to FIG. 6 is set to “1234”. In this case, the method increases the length of the defined subset by 1 (i.e., to “12345”) if the user takes more than the 0.25 second threshold to enter “123”. Similarly, the method increases the length of the defined subset by 1 (e.g., to “123456”) if the user takes more than the 0.30 second threshold to enter “234”. In general, therefore, the subset length adjustment in some embodiments entails increasing the length of the defined subset if the determined time is more than a second threshold. And in at least some embodiments, the adjustment entails a combination of both increases and decreases; that is, decreasing the length of the defined subset if the determined time is less than a first threshold and increasing the length of the defined subset if the determined time is more than a second threshold.

As illustrated with the above example, the method 200 of FIG. 5 may concern the time that the user takes to input multiple different portions of the password. Broadly, then, the method 200 in some embodiments is performed as part of identifying a time-based signature with which the user inputs the defined subset. This signature is characterized by the time that the user takes to input different portions of the defined subset. For example, an authorized user may historically input the password with a particular pattern in terms of the amount of time taken to enter different password portions. This historical pattern effectively functions as a time-based signature for the authorized user. If another user inputs the different portions with a different time-based signature, the method recognizes this difference and increases security by lengthening how much of the password the user must input to be authenticated. That is, the subset length adjustment entails adjusting the length of the defined subset depending on the extent to which a user's time-based signature matches a signature with which an authenticated user has historically input the defined subset.

The embodiments in FIGS. 5 and 6 have been described independently of the retail context, meaning that the embodiments are equally applicable to both retail-affiliated devices 12, customer-owned devices 9, or any other electronic device regardless of its affiliation or ownership. The remaining embodiments below, though, will be described for the scenario where FIGS. 5 and 6 are applied in the retail context.

Consider now a concrete example where the device 12 is a customer-owned device 12G. The device 12G has installed thereon a “local” software application, meaning that the application is executed locally on the device 12G. The local software application allows some non-sensitive functions to be performed upon the customer authenticating himself or herself to the local application. Such functions may include for instance downloading the latest copy of the store planogram to be displayed on the device 12G, so that the customer can walk about the store 10 and procure items (e.g., based on location finding technology). Authentication to the local application may be independent of any hardware level authentication (i.e., the authentication built into or inherent to the device 12G itself), or may be dependent of such hardware level authentication. As one example, the customer authenticates himself or herself at the hardware level using a biometric reader or password. The local software application then polls the device's hardware for any self-identifying or authenticating attributes, so as to exploit the hardware level authentication as authentication for the software application.

Continuing the above example, the local authentication to the device's software application in some embodiments still does not allow the customer to perform at least some functions on the device 12G. Such functions may include for instance scanning items in the store 10 and/or using the local software application to complete payment. Merely performing local authentication therefore means that the customer may have to go to a POS station in the store 10 to actually check out, rather than more conveniently checking out on the device 12G itself. In order to perform these higher-level functions on the device 12G, the customer must log into or otherwise authenticate himself or herself to another apparatus 24 (i.e., a server) that controls the device 12G in this regard and otherwise “drives” the higher-level functions. The apparatus 24 may for instance run the “full-featured” software application, such that when the device 12G is communicatively connected to the apparatus 24 via a local connection in the store 10 the device 12G is able to effectively execute the full-featured software application. That is, the local software application's execution of the higher-level functions is locked unless and until the customer authenticates himself or herself to the other apparatus 24. Alternatively or additionally, the apparatus 24 may store UPC codes and SKU numbers that are loaded to a local folder within the device 12G as needed upon login to the apparatus 24, so that the device 12G need not store the entire UPC/SKU database. Regardless, the apparatus 24 authenticates the customer in this regard according to any of the embodiments herein.

Additionally or alternatively to the embodiments illustrated with FIGS. 3-6, the method 100 and/or 200 in some embodiments configures the extent to which an authentication process at a given time is abbreviated depending on a level of customer activity detected within a retail environment with which the electronic device 12 is affiliated and in which the electronic device 12 is located. In some embodiments, for example, the method 100 and/or 200 configures the authentication process to be more abbreviated when the detected customer activity level is relatively low and to be less abbreviated or not abbreviated at all (i.e., full) when the detected customer activity level is relatively high. This way, for instance, the retail environment realizes prompter customer service when security concerns diminish due to lower customer activity, but better protects sensitive retail-affiliated devices 12 when security concerns rise due to higher customer activity. Security concerns are presumed to diminish when customer activity is low since there will be a greater ratio of store personnel to customers, and store personnel will be less distracted and more vigilant in store security matters regarding who is using the store-affiliated devices.

In some embodiments, the method 100 and/or 200 configures the extent to which the authentication process required at the given time is abbreviated depending on the level of customer activity detected as being actually present at that time. In other embodiments, the method 100 and/or 200 performs such configuration depending on the level of customer activity detected as having occurred during a defined interval before the given time (e.g., as an average activity level within the last 10 minutes). Still other embodiments comprise a combination of the above.

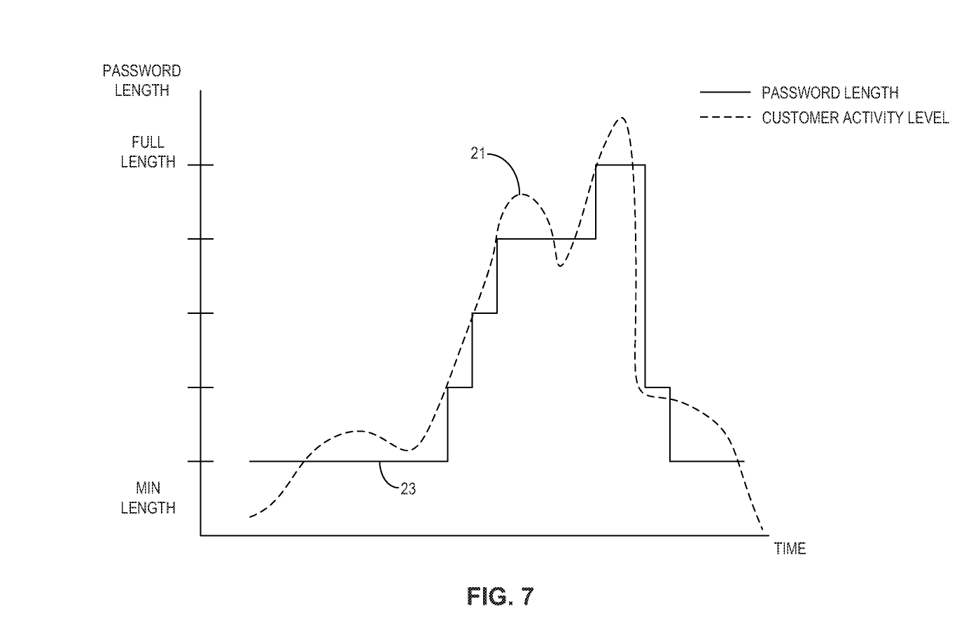

FIG. 7 shows an example of how the method 100 and/or 200 dynamically adjusts the extent to which a password-based authentication process is abbreviated over time as the customer activity level fluctuates, according to some embodiments. As shown, the length of the password required by the authentication process is adjusted (e.g., within a maximum and minimum length) proportionally to, incrementally with, or otherwise in dependence on the customer activity level 21. When the customer activity level 21 increases to a certain extent, the password length is increased to a certain extent as well, and vice versa.

In some embodiments, the apparatus implementing the method 100 (i.e., either device 12 or other apparatus 24) actually detects the level of customer activity. In some embodiments where the device 12 implements the method 100, though, the other node 24 in or otherwise associated with the retail environment detects the level of customer activity based on measurements from one or more sensors in the environment and then sends configuration commands to the device 12 that depend on that detected level.

Regardless, in various embodiments, the level of customer activity detected within the retail environment refers to the level actually detected from measuring characteristics indicative of customer activity (e.g., physical, optical, acoustical, electrical, and/or magnetic characteristics). In some embodiments, for example, the device 12 or other node 24 actually detects the physical presence of customers 11 in the retail environment as an indicator of the customer activity level. In this case, the detection may be based on infrared, ultrasonic, microwave, or tomographic measurements performed by one or more motion sensors 26 in the retail environment. In some embodiments, for instance, the device 12 or other apparatus 24 configures the authentication process to be more abbreviated when the number of customers detected as physically present is relatively low and to be less abbreviated or not abbreviated at all when the number of customers detected as physically present is relatively high.

In other embodiments, the device 12 or other node 24 actually detects network traffic and/or POS transactions in the retail environment as an indicator of the customer activity level. In this case, the detection may be based on measurements that the device 12 or other node 24 performs from network communications and/or transactions.

More particularly in this regard, the method 100 and/or 200 in one or more embodiments configures the extent to which the authentication process required at the given time is abbreviated, depending on a number or rate of recent POS transactions within the retail environment. Recent POS transactions as used herein mean POS transactions occurring at the given time and/or during a defined interval before that given time. This includes POS transactions originating from a retail-affiliated device 12. This also includes POS transactions originating from a mobile checkout application executing on a customer-owned but retail-affiliated device 12. Using such a checkout application, the customer 11 in the retail environment scans or otherwise adds products to be purchased to a shopping cart implemented by the checkout application and then pays using payment information entered into the checkout application or using a designated pay station to which the shopping cart is transferred. Regardless, the number or rate of recent POS transactions within the retail environment excludes any purchasing transactions occurring on a website associated with the retail environment, as such transactions do not occur “within” the retail environment as used herein and are not considered as “POS transactions” as used herein. In some embodiments, the method 100 and/or 200 configures the authentication process to be more abbreviated when the number or rate of recent POS transactions within the retail environment is relatively low and to be less abbreviated or not abbreviated at all when the number or rate of recent POS transactions is relatively high.

In one or more other embodiments, the method 100 and/or 200 configures the extent to which the authentication process required at the given time is abbreviated, depending on a level of recent network traffic attributable to customers within the retail environment. Recent network traffic as used herein comprises traffic occurring on a communication network within the retail environment, including traffic occurring presently at the given time and/or during a defined interval before the given time (e.g., an average traffic level within the last 10 minutes). The communication network may be a wireless local area network, a personal area network, a network that employs short-range wireless beacons (e.g., Bluetooth or Near field Communication), or the like. Traffic on that network is attributable to customers within the retail environment if it is caused by the presence or actions of those customers within the retail environment. This includes traffic caused by customers merely browsing products in the retail environment (e.g., retail surveillance traffic) or merely using their customer-owned device 9 in the retail environment (e.g., internet browsing traffic of a customer 11 connected to the retail environment's communication network). This also includes traffic caused by customers 11 purchasing or servicing products in the retail environment (e.g., retail transactional traffic, whether originating from a retail-owned/leased and retail-affiliated device 12A-B or from a mobile checkout application on a customer-owned but still retail-affiliated device 12G). This further includes traffic caused by retail environment personnel (e.g., store personnel 13) engaging in marketing towards customers in the retail environment. Regardless, the level of such network traffic serves as an indicator of the actual customer activity level and the corresponding security concerns associated with that level. In some embodiments, for instance, the method 100 and/or 200 configures the authentication process to be more abbreviated when the level of recent network traffic attributable to customers is relatively low and to be less abbreviated or not abbreviated at all when the level of recent network traffic attributable to customers is relatively high.

In yet other embodiments, the method 100 and/or 200 configures the extent to which the authentication process required at the given time is abbreviated, depending on a level of recent network traffic originating from or destined to customers' devices 12G, 9. For example, this includes in-store notifications sent to customer-owned devices 12G regarding product pickup, retail environment news, product reviews and/or availability, etc. This also includes traffic originating from or destined to a mobile checkout application executing on a customer-owned device 12G, where such traffic may pertain to POS transactions. This further includes in some embodiments any network traffic (e.g., generic internet browsing) originating from or destined to customer-owned device 9 that are not affiliated with the retail environment. Regardless, in some embodiments, the method 100 and/or 200 configures the authentication process to be more abbreviated when the level of recent network traffic originating from or destined to customers' devices is relatively low and to be less abbreviated or not abbreviated at all when the level of recent network traffic originating from or destined to customers' devices is relatively high.

In still other embodiments, the method 100c and/or 200 configures the extent to which the authentication process required at the given time is abbreviated, depending on a level of recent network traffic originating from or destined to mobile checkout applications executed on customers' electronic devices 12G. Such traffic may pertain to POS transactions or in-store notifications for instance. Regardless, in some embodiments, the method 100 and/or 200 configures the authentication process to be more abbreviated when the level of recent network traffic originating from or destined to mobile checkout applications is relatively low and to be less abbreviated or not abbreviated at all when the level of recent network traffic originating from or destined to mobile checkout applications is relatively high.

In at least some embodiments, the detected level of network traffic and/or the measurements on which such detection is based may be quantified in terms of one or more metrics. Such metrics may include, for instance, the number of connected electronic devices or the number of in-process POS transactions. Another metric may include the rate (e.g., quantity per second, minute, etc.) of packets transmitted and/or received on a local communication network (e.g., LAN) within the retail environment. In some embodiments, the transmission or reception of any packet on the network contributes towards this packet rate, irrespective of its source, destination, or type. In other embodiments, though, the transmission of reception of only select packets on the network contributes towards the packet rate. Select packets in this regard may include for instance only those originating from customers, or only those originating from POS cashiers.

Note that the above embodiments may be performed separately or in combination. Moreover, the embodiments may be performed in combination with other additional embodiments described below. Such additional embodiments include configuring the extent to which the authentication process required for authentication at the given time is abbreviated, depending on whether the electronic device 12 at that given time is directly connected to or within a defined geographical proximity to a network trusted by the electronic device 12.

More particularly in this regard, such may involve designating a network as being trusted by the electronic device 12 in accordance with a command received from a user that previously authenticated himself or herself. Moreover, the authentication process may be configured to be abbreviated to different extents for different networks designated as being trusted by the electronic device 12 to different degrees. These different security degrees or “weights” may be assigned by an authenticated user or by an outside source (e.g., a credit card company).

With regard to geographical proximity, such proximity in some embodiments is determined by a global positioning system (GPS). In other embodiments, the proximity is inferred based on electronic network hops between the device and the trusted network. These hops may indicate for instance the count of how many networks, LANS, or routers a packet has to go through to connect the device and trusted network. The higher the number of hops, the farther the device 12 is presumed to be from the trusted network.

In still other embodiments, the proximity is inferred based on the signal quality (e.g., quality of service, QoS) that the device 12 has with the trusted network. Such signal quality may include for instance packet loss, signal-to-noise ratio (SNR), or the like. If the device 12 has a high signal quality, the device 12 is inferred to be closer to the trusted network, and vice versa.

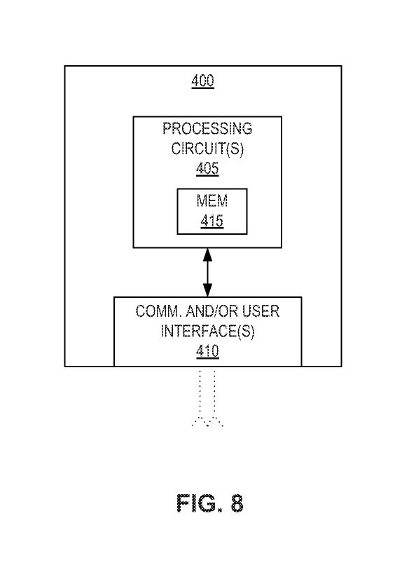

With this understanding, those skilled in the art will appreciate that embodiments herein also include apparatus configured to perform the above-described processing, e.g., in FIGS. 3, 5, and 6. In particular, embodiments herein also include an apparatus 400 shown in FIG. 8. The apparatus 400 is the electronic device 12 in some embodiments, but in other embodiments is another apparatus 24, e.g., associated with the retail environment. As shown, the apparatus 400 comprises one or more processing circuits 405 configured to perform the above-described processing. Particularly where the apparatus 400 is the electronic device 12 itself, the apparatus 400 further comprises a user interface circuit 410 configured to receive input from a user of the electronic device 12 for authenticating himself or herself. Regardless, the apparatus 400 may also comprise one or more communication interface circuits 410. Such communication interface circuits 410 may include various radio-frequency components (not shown) for sending and receiving radio signals over the air via one or more antennas.

Additionally or alternatively, the one or more interfaces 410 may include one or more network interfaces configured to communicate with one or more other network nodes in a network.

Regardless, the one or more processing circuits 405 comprise one or several microprocessors, digital signal processors, and the like, as well as other digital hardware. Memory 415, which may comprise one or several types of memory such as read-only memory (ROM), random-access memory, cache memory, flash memory devices, optical storage devices, etc., stores program code for executing one or more of the techniques described herein. Memory 415 further stores program data, user data, and also stores various parameters and/or other program data for controlling the operation of the apparatus 400.

Of course, not all of the steps of the techniques described herein are necessarily performed in a single microprocessor or even in a single module. Thus, a more generalized control circuit configured to carry out the operations described above may have a physical configuration corresponding directly to the processing circuit(s) 405 or may be embodied in two or more code modules or functional units.

Those skilled in the art will also appreciate that embodiments herein further include a corresponding computer program. The computer program comprises instructions which, when executed on at least one processor, cause the at least one processor to carry out any of the processing described above. Embodiments further include a carrier containing such a computer program. This carrier may comprise one of an electronic signal, optical signal, radio signal, or computer readable storage medium.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method for authenticating a user of an electronic device located in and affiliated with a retail environment, the method comprising:
prohibiting certain operations from being performed on the electronic device in a locked state;
responsive to a user authenticating himself or herself through an authentication process, allowing said certain operations to be performed on the electronic device in an unlocked state; and
configuring an extent to which the authentication process required for authentication at any given time is abbreviated, depending on whether operations performed on the electronic device at or within a defined interval before the given time are included in a defined list of operations, wherein the defined list includes operations performed in the course of business associated with the retail environment with which the electronic device is affiliated and in which the electronic device is located.

2. The method of claim 1, wherein operations included in the list have been defined as operations for which the electronic device is intended.

3. The method of claim 1, wherein the defined list consists of operations associated with point of sale transactions in the retail environment.

4. The method of claim 1, wherein said configuring comprises selecting between at least one of:
different versions of a particular authentication method that each require a different amount of user input; and
different sets of authentication methods that each comprise a different number of authentication methods used in combination.

5. The method of claim 1, further comprising, responsive to determining that operations performed on the electronic device at or within the defined interval before the given time are not included in the defined list, generating an alert indicating such determination and outputting the alert.

6. An apparatus, comprising:
one or more processing circuits configured to:
prohibit certain operations from being performed on an electronic device in a locked state;
responsive to a user authenticating himself or herself through an authentication process, allow said certain operations to be performed on the electronic device in an unlocked state; and
configure an extent to which the authentication process required for authentication at any given time is abbreviated, depending on whether operations performed on the electronic device at or within a defined interval before the given time are included in a defined list of operations, wherein the defined list includes operations performed in the course of business associated with a retail environment with which the electronic device is affiliated and in which the electronic device is located.

7. The electronic device of claim 6, wherein operations included in the list have been defined as operations for which the electronic device is intended.

8. The electronic device of claim 6, wherein the defined list consists of operations associated with point of sale transactions in the retail environment.

9. The electronic device of claim 6, wherein the one or more processing circuits are configured to perform said configuring by selecting between at least one of:
different versions of a particular authentication method that each require a different amount of user input; and
different sets of authentication methods that each comprise a different number of authentication methods used in combination.

10. The electronic device of claim 6, wherein the one or more processing circuits are further configured, responsive to determining that operations performed on the electronic device at or within the defined interval before the given time are not included in the defined list, to generate an alert indicating such determination and output the alert.

11. A method for authenticating a user of an electronic device, the method comprising:
prohibiting certain operations from being performed on the electronic device in a locked state;
responsive to a user authenticating himself or herself by inputting a defined subset of a password beginning from the start of the password, allowing said certain operations to be performed on the electronic device in an unlocked state;
determining the time taken by a user to input a particular portion of the password during an authentication attempt, by determining the time elapsed between when the user begins inputting said portion and when the user finishes inputting said portion; and
adjusting the length of the defined subset that the user must input for said authentication attempt, depending on the determined time.

12. The method of claim 11, wherein said adjusting comprises at least one of decreasing the length of the defined subset if the determined time is less than a first threshold and increasing the length of the defined subset if the determined time is more than a second threshold.

13. The method of claim 12, further comprising setting at least one of the first and second thresholds based on the time that an authenticated user has historically taken to input said portion.

14. The method of claim 11, wherein said determined is performed as part of identifying a time-based signature with which the user inputs the defined subset, said signature characterized by the time that the user takes to input different portions of the defined subset, and wherein said adjusting comprises adjusting the length of the defined subset depending on the extent to which said signature matches a signature with which an authenticated user has historically input the defined subset.

15. An apparatus, comprising:
one or more processing circuits configured to:
prohibit certain operations from being performed on an electronic device in a locked state;
responsive to a user authenticating himself or herself by inputting a defined subset of a password beginning from the start of the password, allow said certain operations to be performed on the electronic device in an unlocked state;
determine the time taken by a user to input a particular portion of the password during an authentication attempt, by determining the time elapsed between when the user begins inputting said portion and when the user finishes inputting said portion; and
adjust the length of the defined subset that the user must input for said authentication attempt, depending on the determined time.

16. The electronic device of claim 15, wherein the one or more processing circuits are configured to at least one of decrease the length of the defined subset if the determined time is less than a first threshold and increase the length of the defined subset if the determined time is more than a second threshold.

17. The electronic device of claim 16, wherein the one or more processing circuits are further configured to set at least one of the first and second thresholds based on the time that an authenticated user has historically taken to input said portion.

18. The electronic device of claim 15, wherein the one or more processing circuits are configured to determine said time as part of identifying a time-based signature with which the user inputs the defined subset, said signature characterized by the time that the user takes to input different portions of the defined subset, and to adjust the length of the defined subset depending on the extent to which said signature matches a signature with which an authenticated user has historically input the defined subset.
